(19) United States
(12) Patent Application Publication
(10) Pub. No.: US 2002/0180972 A1
(43) Pub. Date: Dec. 5, 2002

(54) Particle sizing of flowing fluids, dispersion, and suspension

(76) Inventors: Rafat Razak Ansari, Avon, OH (US); Kwang I. Suh, Petaluma, CA (US)

Correspondence Address: RAFAT R. ANSARI, 3283 N. SANDY LN., AVON, OH, 44011, US

(21) Appl. No.: 09/731,320

(22) Filed: Dec. 6, 2000

Related U.S. Application Data
(60) Provisional application No. 60/169,058, filed on Dec. 6, 1999.

(51) Int. Cl. G01N 15/02

(52) U.S. Cl. 356/336

(57) ABSTRACT

A new application of dynamic light scattering (DLS) is disclosed for the use in accurately and reliably determining the size and/or size distribution of microscopic particles in laminar or turbulent flow. A system of microscopic particles in a fluid medium are forced to be in a laminar, rotational and/or turbulent flow. Then, a coherent light such as laser light is launched into the flowing particles, and the scattered light from the flowing particles is collected, converted into electrical signal, and processed to numerically derive the size/size distribution of the particles in the flow. The technique of DLS has long been used to determine the size/size distribution of the particles in dispersion under static condition. And, it has long been thought that accurate and reliable size determination of the particles in flow is not feasible. Therefore, present invention is the first ever to disclose that the technique of DLS can be used to accurately and reliably measure the size of the particles in flow. The present invention enables true real-time, on line, non-invasive monitoring, and characterization, especially in the field of materials processing, emulsions, colloidal engineering, product quality monitoring, quality monitoring of water and water treatment and other industrial processes. The present invention will also enable the real-time accurate characterization of biological fluid in flow (e.g., blood, biological cells, etc.).

This application claims the benefit of Provisional Application Serial No. 60/169,058, filed on Dec. 6, 1999.

### BACKGROUND OF THE INVENTION

The invention pertains to the field of dynamic light scatting which is also known as quasi-elastic light scattering (QELS), intensity fluctuation spectroscopy (IFS), optical mixing spectroscopy, and photon correlation spectroscopy (PCS). More particularly, this invention pertains to the characterization of microscopic particles in fluid flow. DLS is a widely used technique in studying the hydrodynamic properties of microscopic particles suspended in a fluid medium. Some of the information that can be obtained from DLS include the diffusion coefficient, average particle size, and particle size distribution.

The concept of DLS has been in use for the last half century, and numerous publications and books have been published on the subject. For example, the basic theory and experimental aspect of DLS can be reviewed in the book by Chu [Laser Light Scattering: Basic Principles and Practice, 1991].

In DLS, coherent light such as laser light illuminates microscopic particles dispersed or suspended in a fluid medium. The particles range in size from a few nanometers to a few microns, and the particle dispersion/suspension is contained in a closed container with transparent walls such as a spectroscopic (glass) cuvette. With the laser illuminating, the particles scatter the light over a wide range of angles by Rayleigh or Mie scattering. The intensity of the scattered light fluctuates in time due to the Brownian or thermal motion of the particles in the medium. These fluctuations in the light intensity contain information about the dynamics of the scattering particles. This information can be extracted by constructing a time correlation function (TCF). The TCF is computed using a digital correlator. In the case of dilute dispersions of spherical particles, the TCF provides quick and accurate determination of the translation diffusion coefficient of the particles. Using the Stokes-Einstein equation, the diffusion coefficient can easily be transformed into average particle size provided the viscosity of the suspending medium, its temperature, and refractive index are known.

A typical DLS apparatus includes a source of laser light and a transmitting optical arrangement to launch the laser light into the particle suspension, and a collection optical arrangement to coherently collect the scattered laser light from the particle suspension. The particle suspension is always static and contained. Depending on the areas of use, the particle suspension can be a biological sample contained in a naturally formed container, such as the protein crystallines in the lens of an eye, or it can be an artificially prepared sample put into a transparent container, such as latex particle suspension contained in a plastic cuvette or a glass sample cell. The common theme in all the present DLS applications is that the particles under study are static (not moving) except under Brownian motion and therefore, not flowing. Despite the great success of DLS over the past years, this remains to be the major limitation to measure particle sizes under flowing conditions.

Even though DLS itself is an effective means to characterize microscopic particles, its application so far has been greatly limited by forcing the extraction and preparation of particle suspensions. Therefore, it has been deemed desirable to apply the technique of DLS to accurately and reliably characterize the particles in flow. The present invention contemplates the use of DLS for accurate characterization of particle size and related information while the particles under study are in flow. There are plenty of prior arts that utilize DLS for the characterization of particles in suspension, but there is no prior art in successfully utilizing DLS for the characterization of particles in flow. A technique called Laser Doppler Velocimetry (LDV) is commonly used to measure velocity profiles (not particle size) of particles suspended in a fluid during flowing conditions. This application does not deal with LDV.

### SUMMARY OF THE INVENTION

This invention pertains to the field of dynamic light scattering (DLS) which is also known as quasi-elastic light scattering (QELS), intensity fluctuation spectroscopy (IFS), optical mixing spectroscopy, and photon correlation spectroscopy (PCS). More particularly, this invention pertains to the characterization of particles under flow (laminar, turbulent, or rotational flow) using DLS.

Examples of fluid flow with which this invention can be used include retinal fluid flow, choroidal flow, flow of biological fluids in veins, capillaries and body tissues. The invention may also be used in industrial applications where particles are monitored in fluids flowing in capillaries which may include glass, as well as plastic capillaries or glass or plastic tubes. In general, the disclosed apparatus can be used to monitor or measure particles forming part of flowing fluids which flow through devices (such as capillaries or tubes) having an optical window. The particles being characterized may form part of flowing fluids, dispersions, colloidal suspensions, slurries, etc. The invention is applicable for true non-invasive, on-line monitoring of various processes in which the particles under study are under flow constantly. For instance, on-line, non-invasive characterization of latex particles in paint during the manufacturing process can be achieved. Also, on-line monitoring of contamination in water supply can be achieved without extracting the water sample from the water supply flow.

In accordance with one aspect of the present invention, the application of DLS in flowing particles comprises a coherent light source and a transmitting optical arrangement for transmitting the coherent light to the particles. Further, the invention comprises an arrangement for the particles to be in laminar or turbulent flow. Still further, the invention comprises an arrangement to coherently collect the scattered light from the flowing particles, and the means to derive the size information.

A principle advantage of the invention is its expansion in the use of DLS to the areas of real-time, non-invasive, on-line characterization of particles in flow. A further advantage still other advantages and benefits of the invention will become apparent to those skilled in the art upon a reading and understanding of the following detailed description.

### BRIEF DESCRIPTION OF THE DRAWINGS

The invention may take physical form in certain parts and arrangements of parts, a preferred embodiment of which will be described in detail in this specification and illustrated in the accompanying drawings which form a part hereof, and wherein:

FIG. 1 is a preferred DLS system of the present invention;

FIG. 2 is another preferred DLS system of the present invention;

FIG. 3 is yet another preferred DLS system of the present invention;

FIG. 4 is yet another preferred DLS system of the present invention showing the invention used to characterize the particles in rotational flow.

FIG. 5 is the picture of a preferred DLS system being used for particle sizing of particles under rotational flow.

FIG. 6 is a graph of average particle size obtained from polystyrene solutions (in laminar flow) of different particle sizes and fluid flow speeds.

FIG. 7 is a graph of average particle size obtained from 20 nm polystyrene solutions (in rotational flow) of different fluid flow speeds.

### DETAILED DESCRIPTION OF THE PREFERRED EMBODIMENT

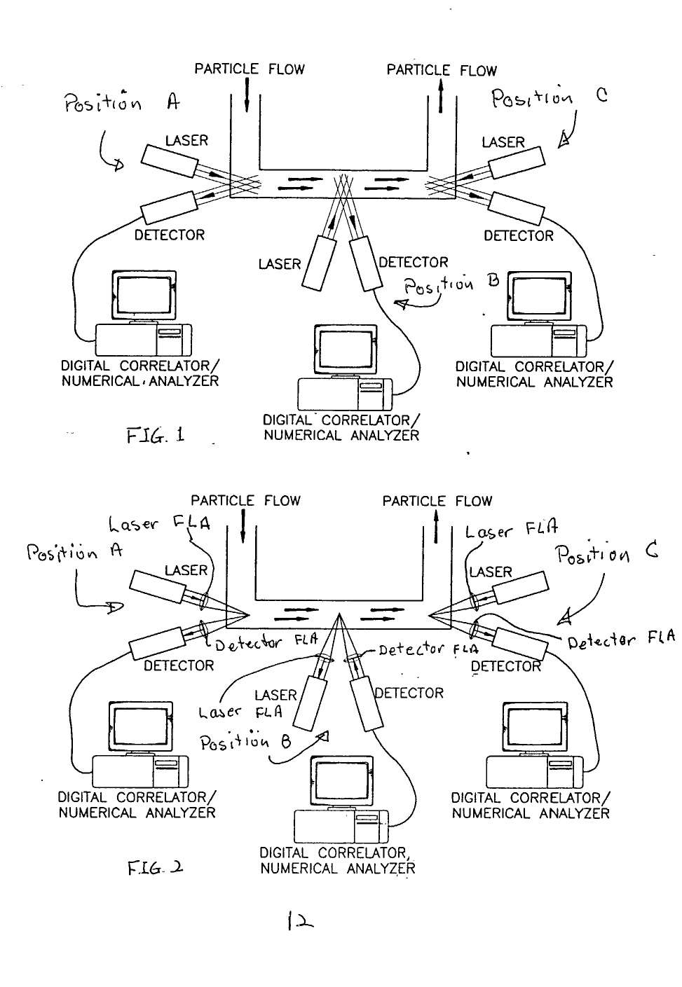

FIG. 1 shows a preferred embodiment of the invention of a simple laser—particle flow —detector arrangement. The particles in fluid medium are flowing through a tube, and a laser is launching a coherent light into the flowing particles. A photo-detector (such as a photo multiplier or APD—Avalanche Photo Diode) is positioned in such a way that scattered light from the illuminated flowing particles are picked up at certain scattering angle.

In order to ensure the maximum energy transmission, the tube is made of transparent material such as glass or plastic. However, for the use in certain conditions, such as measurement of blood in veins, the set-up will be directly on the given path of flowing particles.

The photo-detector will convert the optical signal (scattered light) into electrical signal and fed to the digital correlator which uses the electrical signal to process and numerically derive the necessary information (particle size and/or size distribution). Also shown in FIG. 1, the laser and detector set-up can be positioned in different ways with respect to direction of flows—away from the flowing direction (Position A), parallel to the flow direction (Position B), or facing or perpendicular to the flow direction (Position C).

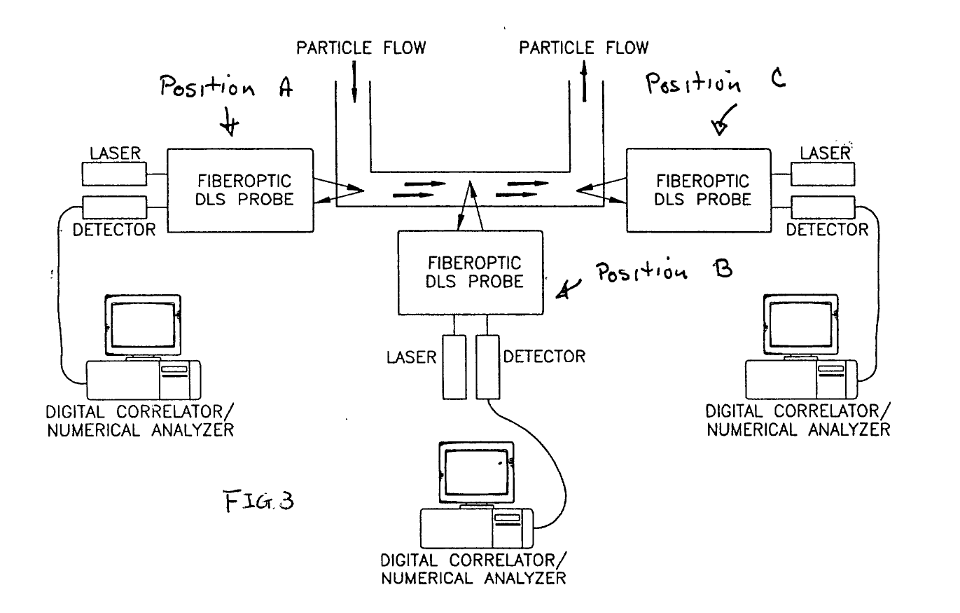

FIG. 2 shows another preferred embodiment of the invention. In this case, the coherent light from the laser is focused into the flowing particles using a focusing lens assembly (laser FLA). The lens assembly can be a single or multiple lens configuration. Also, the detector has a focusing lens assembly (detector FLA) attached in the front in order to collect the scattered light from the focused illumination of the flowing particles. The mechanism of optical to electrical conversion and signal processing/numerical analysis are the same as FIG. 1. The laser and detector setup can also be placed in three different positions as the apparatus shown in FIG. 1.

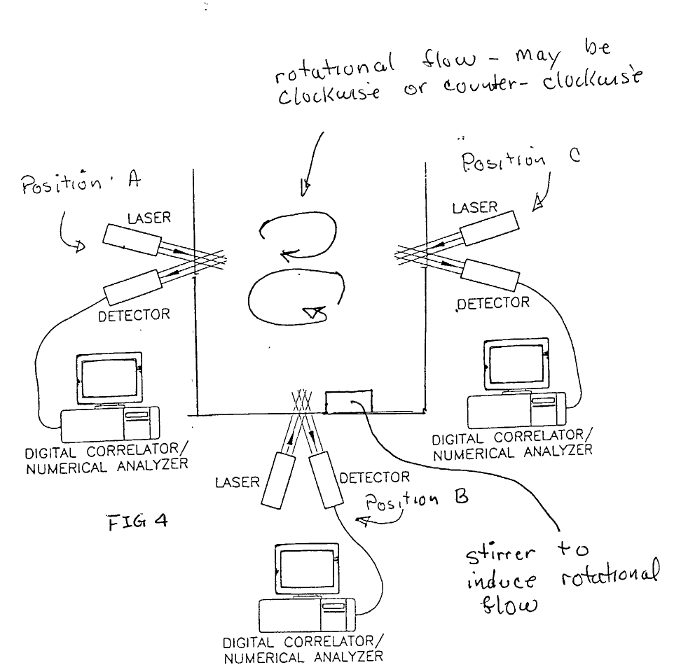

In another preferred embodiment in FIG. 3, the laser launching optics and scattered light collecting optics are integrated into a small probe using the fiber optics technology (fiber optic DLS probe). The coherent light from the laser is launched into one end of transmitting fiber, and then launched laser light is transmitted through the transmitting fiber to the other end of the transmitting fiber. The transmitted laser light goes through the transmitting lens, and is focused into the flowing particle. The scattered light from the focused illumination of the flowing particles is collected by the receiving lens and launched into one end of receiving fiber. The launched scattered light is transmitted through the receiving fiber to the other end of the receiving fiber, and launched to the photo detector. The other end of the transmitting fiber, the transmitting lens, the receiving lens and the other end of the receiving fiber are all put together in one integrated probe body. Also, depending on the position of the ends of fibers against the lenses, the resulting illuminated area in the flowing particle can be focused, or collimated, or diverged.

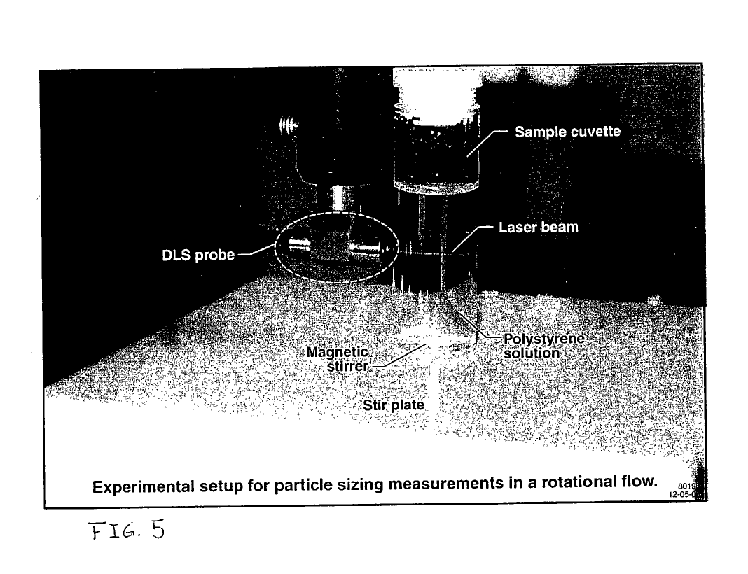

FIG. 4 illustrated another preferred embodiment of the invention which can be used to characterize particle size or particle size distribution in a fluid having rotational flow. As seen in FIG. 4, this may occur in a vessel where a device such as a stirrer is used to impart rotation to the fluid contained in the vessel. As indicated schematically, the fluid flow may rotate in the clockwise or counterclockwise direction, or both. The principles of operation of the apparatus are the same as those discussed above in connection with FIGS. 1-3.

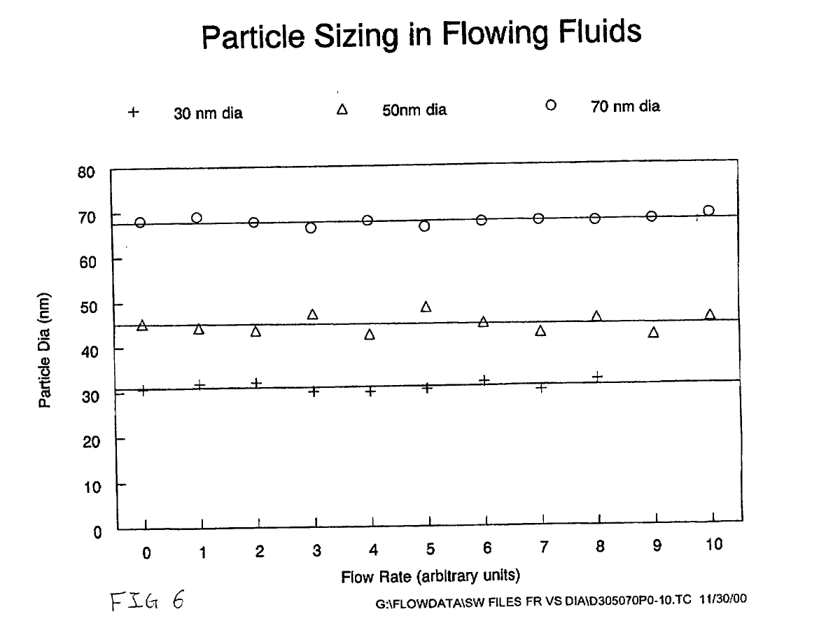

FIG. 5 shows a picture of a preferred embodiment (fiber optic DLS probe) being used for particle sizing of polystyrene solution under rotational flow. The fiber optic DLS probe may be the same or similar to the probe disclosed in U.S. Pat. No. 5,973,779, which is hereby incorporated by reference.

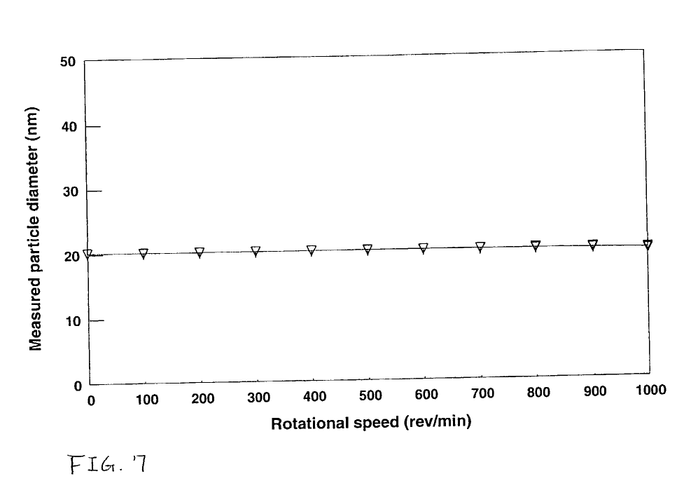

FIGS. 6 shows the analyzed average particle size of various size polystyrene standard solutions under flow as a function of flow speed, measured using the fiber optic DLS probe at a position parallel to the flow direction. Also, FIG. 7 shows the analyzed average particle size of 20 nm polystyrene standard solution under rotational flow as a function of flow speed, measured using the fiber optic DLS probe at a position perpendicular to the flow position. It is clear from the data (FIGS. 6 and 7) that the fiber optic DLS probe (U.S. Pat. No. 5,973,779) can reliably and accurately determine the particle size from a very wide range of samples at a wide range of flow speed.

As noted above, the invention can be used to characterize particles carried by a flowing fluid. The term “fluid” as contemplated by the present invention also included dispersions, colloidal suspensions, slurries, etc. In industrial applications the apparatus may be used to characterize particles flowing through glass, plastic, or other synthetic capillaries, as well as plastic tubes and other flow controlling devices that include an optical window through which the laser light and scattered light can be transmitted. The invention has been described with reference to the preferred embodiment and additional embodiments. Obviously, modifications and alterations will occur to others upon a reading and understanding of this specification. It is intended to include all such modifications and alterations in the scope of the invention.

I claim:

1. A DLS method for measuring the size or size distributions of particles under flowing conditions comprising:
a) means to have particles in a laminar, turbulent, and/or rotational flowing condition with an ability to transmit light to and from the particles under flowing conditions (e.g., a window);
b) means to launch a coherent light (e.g., laser) to particles under flowing conditions;
c) means to detect the light scattered off the particles under flowing conditions (e.g., photo detector); and
d) means to perform signal processing and analyze the size or size distribution of the particles under flowing conditions (e.g., digital correlator and numerical analysis software).

2. A DLS method for measuring the size or size distributions of particles under flowing conditions comprising:
a) means to have particles in a laminar, turbulent, and/or rotational flowing condition with an ability to transmit light to and from the particles under flowing conditions (e.g., a window);
b) means to launch a focused coherent light (e.g., laser with focusing lens assembly) to particles under flowing conditions;
c) means to detect the light scattered off the particles under flowing conditions (e.g., photo detector with focusing lens assembly); and
d) means to perform signal processing and analyze the size or size distribution of the particles under flowing conditions (e.g., digital correlator and numerical analysis software).

3. A DLS method for measuring the size or size distributions of particles under flowing conditions comprising:
a) means to have particles in a laminar, turbulent, and/or rotational flowing condition with an ability to transmit light to and from the particles under flowing conditions (e.g., a window); and
b) the apparatus described in U.S. Pat. No. 5,973,779.
